(19) United States
(12) Patent Application Publication
(10) Pub. No.: US 2016/0047302 A1
(43) Pub. Date: Feb. 18, 2016

(54) Reciprocating cradle engine

(71) Applicant: Thomas Lee Fillios, SR., Boston, MA (US)

(72) Inventor: Thomas Lee Fillios, SR., Boston, MA (US)

(73) Assignee: Thomas Lee Fillios, SR., Lexington, MA (US)

(21) Appl. No.: 14/121,209

(22) Filed: Aug. 12, 2014

(51) Int. Cl. F02B 75/32; F02B 75/18; F01P 3/22

(52) U.S. Cl. CPC F02B 75/32; F01P 3/22; F02B 75/18

(57) ABSTRACT

Method and apparatus for oil-less engine with a reciprocating cradle is described. Oil-less engine allows manufacturers to build environmentally safer oil-free engines, with fewer engine parts and at reduced costs of manufacturing. In one embodiment, the present invention an internal combustion engine comprising a reciprocating cradle having pistons. The cradle is assembled with a circular disk that rotates. The rotation of the circular disk causes the pistons and the cradle to reciprocate and thereby causing a combustion with cylinder heads.

### FIELD

Embodiments of the present invention relate generally to engines and motors. More specifically, embodiments of the invention relate to internal combustion of oil-less engines.

### BACKGROUND

Prior art engines often utilize engine oil for lubricating pistons and cylinders. Engine oil produces pollutants, causing pollution to environment. Prior art engines also comprise numerous moving or wearable parts. Such parts include, but are not limited to, nuts and bolts, pushrods, valves, lifters, rod bearings, rockers, rocker posts, springs, chains, sprockets, and sprocket covers. These parts contribute to the issues of increased size and weight, lower reliability, and higher costs of manufacturing. Given the aforementioned issues, prior art engines have insufficient environmental safety, reliability and economics in manufacturing.

### SUMMARY

The present invention improves environmental safety standards of internal combustion engines by eliminating the use of engine oil in the internal combustion area of an engine, thus reducing pollutants and increasing environmental safety. The invention reduces the number of engine parts of prior art engines, thereby minimizing engine weight and lowering the costs of production. The present invention also increases reliability and efficiency of an engine by reducing the number of wearable engine parts that include, but are not limited to, camshafts, valves, lifters, rod bearings, rockers, springs, and sprockets.

In one embodiment, the present invention is an oil-less internal combustion engine, the engine comprises an engine casing with a cradle; said cradle comprising a plurality of pistons, each piston connected to said cradle by a piston rod; a plurality of cylinder walls corresponding to said plurality of pistons, wherein each cylinder wall has a cylinder head comprising a fuel injector, a sparking means, an air injector and an exhaust eliminator, and wherein said each cylinder wall is adapted to hold said each piston; a circular disk assembled in said cradle, wherein said disk is adapted to rotate, and wherein said cradle performs a reciprocation when said disk rotates; and a crankshaft connected to said disk, wherein said crankshaft is adapted to transfer mechanical power to a transmission, and wherein said internal combustion engine is oil-less.

Other embodiments of the present invention are described in the detailed description below.

### BRIEF DESCRIPTION OF THE DRAWINGS

The embodiments of the present invention described herein are exemplary, and not restrictive.

FIG. 1 is an embodiment identifying engine sections of an engine of the present invention, when the cradle is down.

FIG. 2 is an embodiment identifying engine sections of an engine of the present invention, when the cradle is up.

FIG. 3A is an embodiment of an exhaust eliminator when the exhaust is closed.

FIG. 3B is an embodiment of an exhaust eliminator when the exhaust is opened.

FIG. 4A is an embodiment of the engine of the present invention when a piston is in up position.

FIG. 4B is an embodiment of the engine of the present invention when a piston is in down position.

FIG. 5 is an embodiment of the engine showing a plurality of air conditioning (AC) modules and a plurality of coolant jackets in the engine casing of the present invention.

FIG. 6 is an embodiment of the engine of FIG. 1 showing an electric spark (spark tip).

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Advantageously, the present invention improves environmental safety of internal combustion engine by eliminating the use of engine oil from the internal combustion area of an engine, thus reducing pollutants. Further, the invention reduces the number of engine parts of prior art engines, thereby minimizing engine weight and lowering the costs of production. The present invention also increases reliability and efficiency of an engine by reducing the number of wearable engine parts that include, but are not limited to, camshafts, valves, lifters, rod bearings, rockers, springs, and sprockets.

Technical know-how, functionalities and operation of prior art engines are known to a person of ordinary skill in the art of engine making. The description herein focuses on novelty in a manner that the solution concept of the present invention is discernable from prior art engines. Embodiments covering dimensions and engineering specifications of the present invention are not restrictive, meaning inclusive, to the present invention. Dimensions and engineering specifications are known to a person of ordinary skilled in the art. Dimensions and specification are customizable.

For the purpose of the present invention, the term “oil-less” is used to describe an engine that does not use engine oil for lubrication in its internal combustion area. However, oil or lubricating agents may be used outside of internal combustion area for lubricating mechanical assembly, such as, crankshafts and bearings.

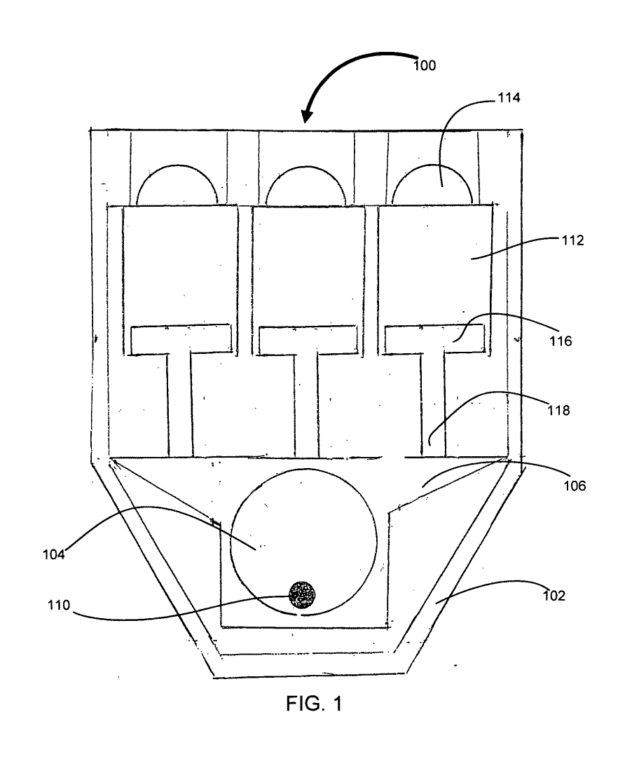

With reference to FIG. 1 to FIG. 6, embodiments of an engine of the present invention are described below. The phrase “an embodiment” refers to an embodiment of an engine of the present invention.

FIG. 1 is an embodiment 100 showing parts of engine of the present invention. An engine casing 102 holds a cradle 106. The cradle 106 houses a disk 104. The disk 104 rotates either clockwise or counterclockwise. The cradle is adapted in a way that when the disk 104 rotates, the cradle moves up and down or reciprocates. In one embodiment, the cradle is adapted to reciprocate using a rack and worm gear. The cradle comprises a rack gear and the disk comprises a worm gear. The cradle 106 also holds a plurality of pistons. A piston 116 has a piston rod 118. The piston rod 118 maybe screwed into the cradle 106. The piston 116 moves along a cylinder wall 112. The upper part of the cylinder wall 112 has a cylinder head 114 (also called, a combustion chamber). The combustion chamber 114 comprises a fuel injector, an air injector, an sparking means and an exhaust means (exhaust eliminator). At 110, a crankshaft connects to the disk 104. The disk when rotates will cause the crankshaft to transfer mechanical power to a transmission. The embodiment 100 shows the parts of the engine when the cradle 106 is in down position.

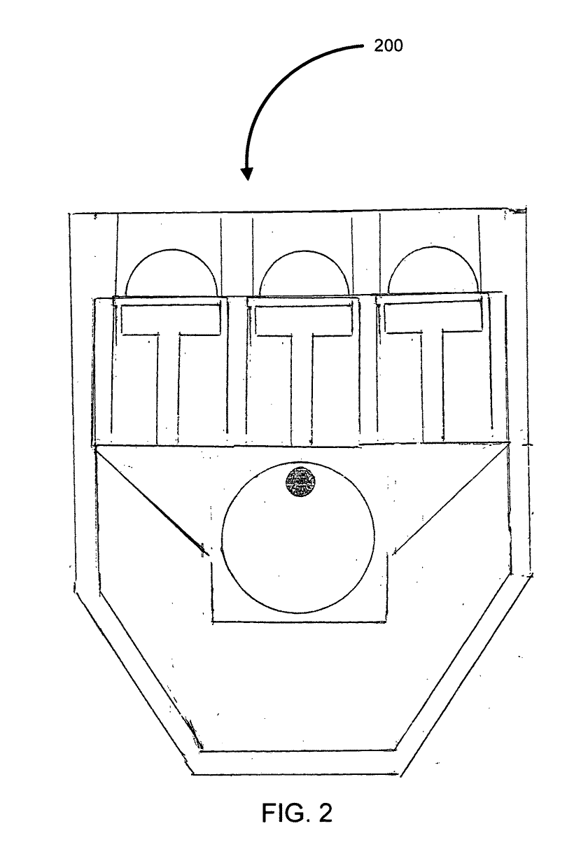

FIG. 2 is an embodiment 200 showing parts of engine of the present invention, when the cradle is in up position. When the cradle is in up position, a combustion may commence at combustion chambers.

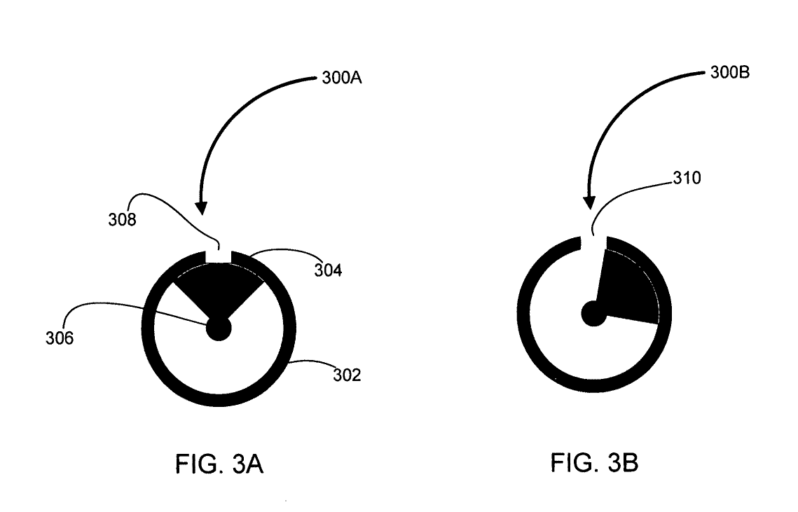

FIG. 3A is an embodiment 300A of an exhaust eliminator when the exhaust is closed or sealed off. The exhaust eliminator may be electronically controlled by a car computer. An exhaust sealer 304 rotates around an axis 306 inside the perimeter 302, thereby sealing off the opening 308.

FIG. 3B is an embodiment 300B of an exhaust eliminator when the exhaust is open. When the exhaust is open, the opening 310 is unobstructed by the exhaust sealer.

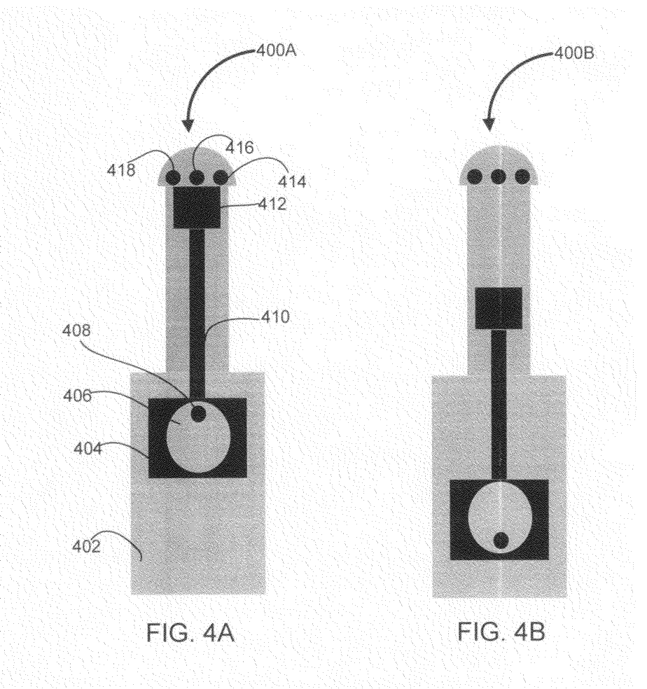

FIG. 4A is an embodiment 400A of a cradle and a single piston of the present invention, when the piston is in up position. A cradle 404 moves inside the engine casing 402. A rotation of a disk 406 causes the cradle 404 to move along the casing 402. A rack and worm gear is implemented between the cradle and the disk to cause a reciprocation of the cradle when the disk rotates. A piston rod 410 comprising a piston 412 is screwed into the cradle 404. A combustion chamber comprises an fuel injector 418, an air injector 416, a sparking means and an exhaust means (exhaust eliminator). A crankshaft 408 is connected to the disk 406. The crankshaft transfers mechanical power from the disk to a transmission when the disk generates mechanical power by rotation. The disk rotates when a combustion happens. A piston rod 410 connects a piston 412 to the cradle 404. A cylinder head (or combustion chamber) comprises a sparking means 418, an air injector 416, and a fuel injector 414. The cylinder head also comprises an exhaust means or exhaust eliminator that is electrically controlled by a car computer. When the piston 412 approaches the cylinder head, a combustion happens, causing the piston to move down, thereby rotating the disk 406.

FIG. 4B is an embodiment 400B of a cradle and a single piston of the present invention, when the piston is in down position. When the piston is down, a mixture of fuel and air is formed inside the cylinder wall. As the piston moves up, the mixture is compressed. When the piston is at a top dead center position, a combustion happens. The cylinder wall may be made of composite materials.

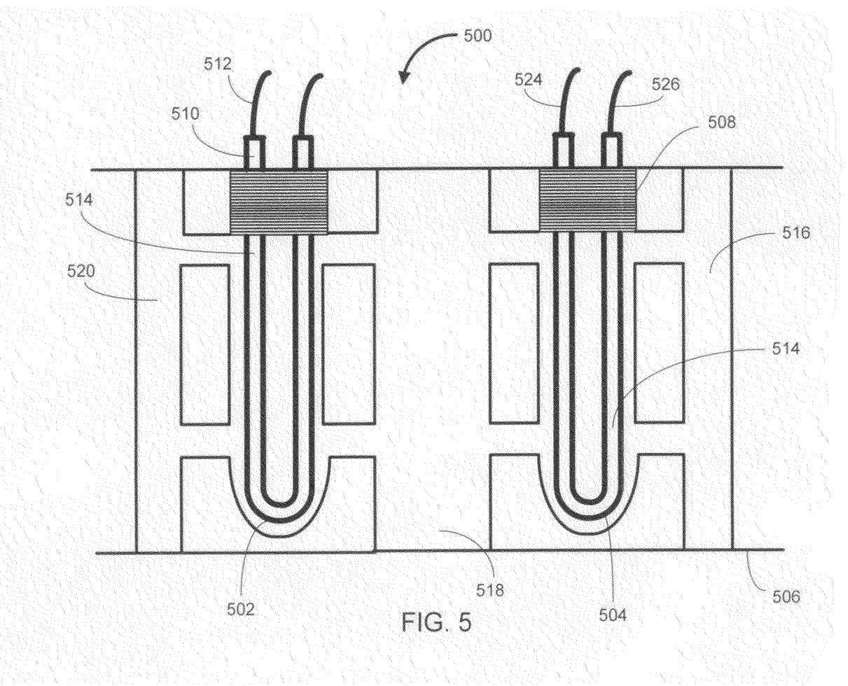

FIG. 5 is an embodiment 500 showing a plurality of air conditioning (AC) modules (502 and 504). AC modules are used optionally, in addition to coolant (at coolant jackets) in an engine casing, to improve the process of heat elimination from the casing. An AC module 504 is screwed on to a coolant hole 508 of an engine casing 506. An AC module has an inlet 524 and an outlet 526 for air conditioning (AC) fluid to pass. An inlet or outlet comprises an oil fitting and an oil tubing. An oil fitting 510 along with an oil tubing 512 transfers AC fluid to the AC module 502 from an AC condenser. An AC condenser of an automobile air conditioner may be used for the application discussed herein. An AC module has a pipe 514 that connects an inlet 524 to an outlet 526. Alternatively, coils may be used in place of a pipe. AC fluid passing through a pipe or coils transfers heat out from the engine casing 506. The engine casing 506 has a plurality of coolant jackets (516, 518, 520). A combination of coolant jackets and AC modules operate to maintain the temperature of the engine casing 506.

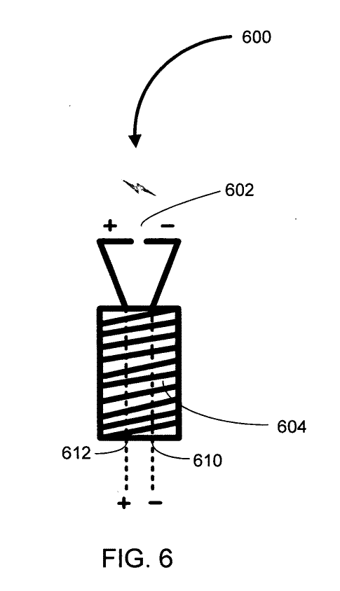

FIG. 6 is an embodiment 600 showing a spark tip of a spark plug or sparking means. A positively charged wire and a negatively charged wire create a spark at 602 where the positively charged wire and the negatively charged wire meet together. Electricity is passed through the spark rod to the spark tip by using insulated wires: a positive wire 612 and a negative wire 610.

Embodiments of the present invention may use an screw-on assembly of modular engine parts. However, a person of ordinary skill in the art knows that alternative means of attachment, such as, nuts and blots, may be used to achieve identical functionalities of the present invention. In another embodiment, two or more engine parts of the present invention may be casted in a single mold, thus avoiding a screw-on assembly or nut and bolt assembly.

Reference in this specification to “one embodiment” or “an embodiment” means that a particular feature, structure, or characteristic described in connection with the embodiment is included in at least one embodiment of the invention. The appearance of the phrases “in one embodiment” or “an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Although the written description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be practiced independently of other features. Accordingly, the description of the invention is set forth without any loss of generality to, and without imposing limitations upon, the invention.

Although the present invention has been described with reference to specific exemplary embodiments, it will be evident that various modification and changes can be made to these embodiments without departing from the broader spirit of the invention. Accordingly, the specification and drawings are to be regarded in an illustrative sense rather than in a restrictive sense.

1. An oil-less internal combustion engine, the engine comprising:
(a) an engine casing comprising a cradle;
(b) said cradle comprising a plurality of pistons, each piston connected to said cradle by a piston rod;
(c) a plurality of cylinder walls corresponding to said plurality of pistons, wherein each cylinder wall has a cylinder head comprising a fuel injector, a sparking means, an air injector and an exhaust eliminator, and wherein said each cylinder wall is adapted to hold said each piston;
(d) a circular disk assembled in said cradle, wherein said disk is adapted to rotate, and wherein said cradle performs a reciprocation when said disk rotates; and
(e) a crankshaft connected to said disk, wherein said crankshaft is adapted to transfer mechanical power to a transmission.

2. (canceled)

3. The engine of claim 1, wherein said plurality of pistons, when at reciprocation, do not leave said plurality of cylinder walls.

4. The engine of claim 1, wherein said cylinder walls are made of composite materials.

5. The engine of claim 1, wherein said engine casing comprises an air conditioning (AC) module.
